(19) United States
(12) Patent Application Publication
(10) Pub. No.: US 2025/0156903 A1
(43) Pub. Date: May 15, 2025

(54) SERVING CONTENT

(71) Applicant: BLIS GLOBAL LTD, London (GB)

(72) Inventors: Aaron Kameron MCKEE, Trumbull, CT (US); Stefanos Nikolaou, Glasgow (GB); Daniel David Peter Scott, Edinburgh (GB)

(21) Appl. No.: 18/942,923

(22) Filed: Nov. 11, 2024

Related U.S. Application Data
(60) Provisional application No. 63/548,003, filed on Nov. 10, 2023.

(51) Int. Cl. G06Q 30/0251; G06Q 30/0242

(52) U.S. Cl. CPC G06Q 30/0261; G06Q 30/0242

(57) ABSTRACT

A processing system receives audience area data defining a plurality of geographical entities. The entries are clustered in response to geographical data for the entities by processing the geographical data with audience movement signals representing audience movement between the entities, to define a plurality of entity clusters. Audience similarity is quantified for selected pluralities of the geographical entities by obtaining similarity scores for entities in different entity clusters. Similar entities are allocated to a holdout group and a preferred group in response to their similarity score. Content is served to the preferred group thereby optimally configuring audience devices for subsequent measurement of audience uplift.

### CROSS REFERENCE TO RELATED APPLICATIONS

This application claims priority from U.S. Patent Application No. 63/548,003, filed on November 10, 2023, the whole contents of which are incorporated herein by reference.

### BACKGROUND OF THE INVENTION

The present invention relates to serving content to an audience via a computer network. In particular, it relates to determining where audience content should be served.

The majority of online services are funded by advertising. The effectiveness of advertising can be measured automatically by gathering large amounts of data that tracks user behaviour across multiple locations and networks. Increasingly, user tracking is subject to laws intended to maintain user privacy. This results in a tension between the funding of services by advertising, and privacy of users of those services.

As a result, the efficacy of advertising campaigns is becoming increasingly difficult to measure using established methods. From the point of view of advertisers, this results in greater costs in placing advertisements. From the point of view of users, their privacy is increased, but advertisements they see are less relevant and waste the users' time.

Considerable infrastructure for bidding for and placing online advertisements already exists, but its value is being eroded as user privacy is increasingly protected. Ideally, such infrastructure would be used to provide relevant and useful advertising, while respecting and enabling privacy.

### BRIEF SUMMARY OF THE INVENTION

According to a first aspect of the present invention there is provided a method performed by a processing system configured to receive audience movement signals responsive to audience movement between a plurality of geographical entities and to process the movement signals with audience area data representing the plurality of geographical entities; the method comprising clustering the entities by processing the audience movement signals with the audience area data to define a plurality of entity clusters, quantifying audience similarity for selected pluralities of the geographical entities by obtaining similarity scores for entities in different entity clusters, allocating similar entities to a holdout group and a preferred group in response to their quantified audience similarity, and preferentially transmitting content signals to audience devices for audience members in the preferred group, thereby establishing an optimal audience device configuration for subsequent measurement of audience uplift.

The method may include measuring audience uplift in response to signals for a resulting audience behavior in the preferred group and signals for a corresponding audience behavior in the holdout group.

The allocating method may include allocating a geographical entity to a buffer group that geographically separates a portion of the holdout group from the preferred group.

The clustering step may include defining the plurality of entity clusters in response to the geographical data in a distance matrix.

The clustering step may further include defining the plurality of entity clusters in response to the audience movement signals in a cross-pollination matrix.

According to a second aspect of the present invention, there is provided an apparatus for serving content to audience devices on a network in response to audience movement signals responsive to audience movement between a plurality of geographical entities and to process the movement signals with audience area data representing the plurality of geographical entities, the apparatus comprising one or more processors configured to perform steps of clustering the entities by processing the audience movement signals with the audience area data to define a plurality of entity clusters, quantifying audience similarity for selected pluralities of the geographical entities by obtaining similarity scores for entities in different entity clusters, allocating similar entities to a holdout group and a preferred group in response to their quantified audience similarity, and preferentially transmitting content signals to audience devices for audience members in the preferred group, thereby establishing an optimal audience device configuration for subsequent measurement of audience uplift.

One or more processors may be further configured to measure audience uplift in response to signals for a resulting audience behavior in the preferred group and signals for a corresponding audience behavior in the holdout group. The one or more processors may be further configured such that the allocating includes allocating a geographical entity to a buffer group that geographically separates a portion of the holdout group from the preferred group. One or more processors may be further configured such that the clustering includes defining the plurality of entity clusters in response to the geographical data in a distance matrix. Furthermore, one or more processors may be configured to pre-calculate elements of the distance matrix. One or more processors may be configured to define the plurality of entity clusters in response to the audience movement signals in a cross-pollination matrix. One or more processors is configured such that the quantifying audience similarity includes obtaining the similarity scores by calculating a cosine similarity between normalized audience characteristics for respective entities.

According to a third aspect of the present invention, there is provided a computer-readable medium having instructions stored upon it wherein said instructions configure a computer system for serving content to audience devices on a network in response to audience movement signals responsive to audience movement between a plurality of geographical entities and to process the movement signals with audience area data representing the plurality of geographical entities by performing steps of clustering the entities by processing the audience movement signals with the audience area data to define a plurality of entity clusters, quantifying audience similarity for selected pluralities of the geographical entities by obtaining similarity scores for entities in different entity clusters, allocating similar entities to a holdout group and a preferred group in response to their quantified audience similarity, and determining to transmit content signals to audience devices for audience members in the preferred group, thereby establishing an optimal audience device configuration for subsequent measurement of audience uplift.

The computer-readable medium further includes instructions to measure audience uplift in response to signals for a resulting audience behavior in the preferred group and signals for a corresponding audience behavior in the holdout group.

The computer-readable medium further includes instructions for allocating a geographical entity to a buffer group that geographically separates a portion of the holdout group from the preferred group.

The computer-readable medium further includes instructions such that the clustering includes defining the plurality of entity clusters in response to the geographical data in a distance matrix. The computer-readable medium further includes instructions to define the plurality of entity clusters in response to the audience movement signals in a cross-pollination matrix.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an environment for serving advertising content to an audience via a network, including a campaign configuration and control server, a holdout manager and an uplift measurement server;

FIG. 2 details steps performed by the campaign configuration and control server shown in FIG. 1, including a step of supplying a list of entities and a step of receiving a list of entity groups;

FIG. 3 illustrates the step of supplying a list of entities and the step of receiving a list of entity groups shown in FIG. 2;

FIG. 4 details hardware components of the holdout manager shown in FIG. 1, including a central processing unit (CPU), a non-volatile computer-readable medium drive and random-access memory;

FIG. 5 details the contents of the non-volatile computer-readable medium drive shown in FIG. 4, including pre-calculation instructions and holdout manager instructions;

FIG. 6 details the contents of the random-access memory shown in FIG. 4, including a distance matrix and a cross-pollination matrix;

FIG. 7 details steps performed by the CPU shown in FIG. 4 while executing the pre-calculation instructions shown in FIG. 5;

FIG. 8 details geographical entities in the list of entities supplied in FIG. 2;

FIG. 9 details steps performed by the CPU shown in FIG. 4 while executing the holdout manager instructions shown in FIG. 5, including a step of clustering, a step of allocating clustered entities to groups A and B and a step of allocating clustered entities to groups C and D;

FIG. 10 details the distance matrix and the cross-pollination matrix shown in FIG. 6;

FIG. 11 details the clustering step shown in FIG. 9;

FIG. 12 illustrates the effect of the clustering step shown in FIG. 9;

FIG. 13 details the step of allocating clustered entities to groups A and B shown in FIG. 9, including a step of finding a matching candidate;

FIG. 14 details the step of finding a matching candidate shown in FIG. 13, including a step of searching through unused clusters, including a step of obtaining a similarity score;

FIG. 15 details the step of searching through unused clusters shown in FIG. 14, including a step of obtaining a similarity score;

FIG. 16 illustrates the steps of obtaining a similarity score shown in FIG. 14 and FIG. 15;

FIG. 17 details the step of allocating clustered entities to groups C and D shown in FIG. 9;

FIG. 18 illustrates the effect of the steps of FIG. 9;

FIG. 19 details steps performed by the uplift measurement server shown in FIG. 1; and

FIG. 20 illustrates results provided by performing the steps shown in FIG. 19.

### DETAILED DESCRIPTION OF THE INVENTION

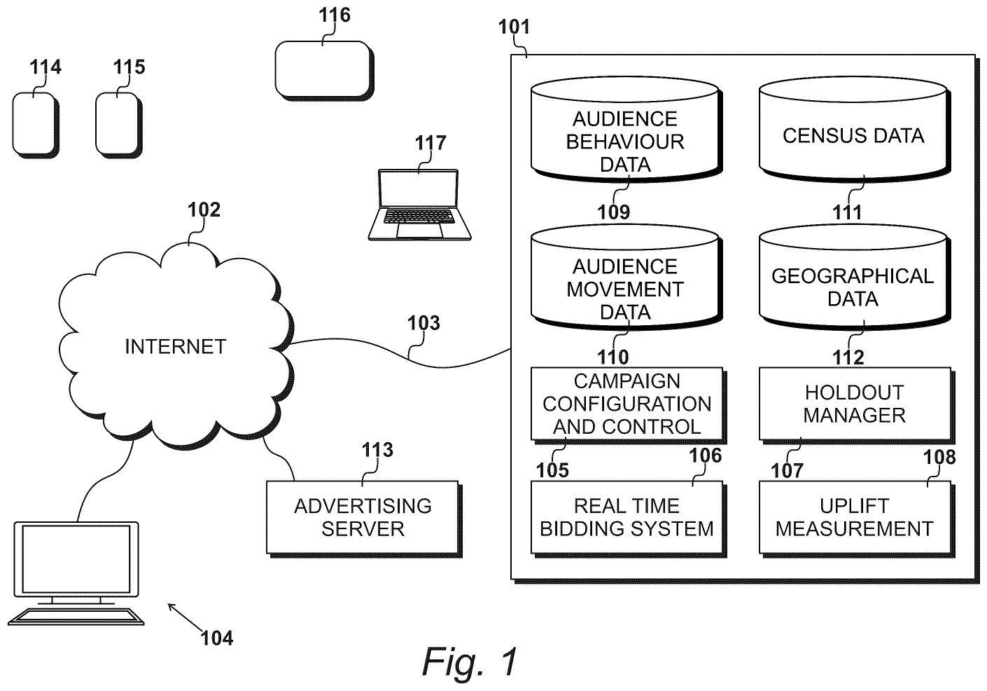

### FIG. 1

An environment for serving content to an audience via a network is shown in FIG. 1. A campaign content control and measurement system 101 is connected to the Internet 102 via a fibre-optic data connection 103. A configuring terminal 104 interacts with components of the system 101 to configure an advertising campaign. Components of the system 101 include a campaign configuration and control server 105, a real-time bidding system 106, a holdout manager 107 and an uplift measurement server 108. Data stored on the system 101 includes anonymized audience behaviour signals 109, audience movement signals 110, census data 111 and geographical data 112. Audience movement signals 110 includes signals representing movement of audience devices within and between geographical entities. These audience movement signals 110 derive from anonymised location-specifying transmissions from potentially millions of audience devices. The configuration terminal 104 communicates via the Internet 102 with the campaign configuration and control server 105, which sets up and runs an advertising campaign by communicating with the other system components 106 to 112. In certain embodiments, components 105 to 112 may be individually or collectively implemented as a computer system located in the same or multiple locations.

Once configured, the real-time bidding system 106 communicates with an advertising server 113 via the Internet 102. The bidding system 106 automatically bids for advertising slots as these become available in various locations and on various user devices connected to the Internet 102.

Connected audience devices include mobile phones 114 and 115, a tablet 116 and a laptop computer 117. Such devices facilitate access to an audience of millions of users. Applications running on the devices 114 to 117 automatically include advertising slots whose availability is mediated by the advertising server 113, which sells slots, as they become available, to the highest bidder in a bidding war that takes place in real time.

In such an environment, the ability to determine the effectiveness of an advertising campaign is valuable. At the same time, increasing privacy measures make it more difficult for advertisers to directly measure the performance of advertising campaigns. The system 101 optimises advertising by configuring audience devices 114 to 117 in such a way as to optimally measure the effectiveness of an advertising campaign while respecting user privacy. The key component which enables this is the holdout manager 107.

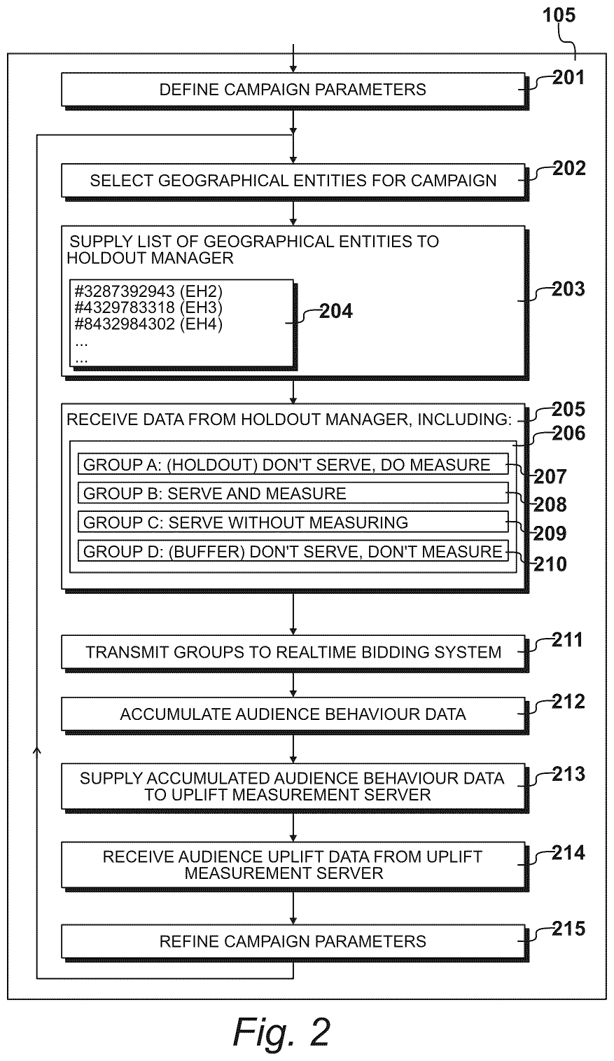

### FIG. 2

Actions performed by the campaign configuration and control server 105 in response to instructions from the configuration terminal 104 are summarized in FIG. 2. At step 201 campaign parameters are received from the terminal 104. Such parameters include the timing of the campaign, bidding parameters such as maximum expenditure, sources of content for the advertisements that will be served, and so on. At step 202 geographical entities are selected for the campaign. The geographical entities are postal districts. Usually, such entities are non-overlapping, but due to their being based on historical postal delivery routes, it is possible for some small amount of entity overlap to occur in some countries. Hence, the term geographical entity should not be taken in a limited sense to mean a strictly two-dimensional area; it can encompass a variety of interpretations, based on or similar to, but not limited to geographical area. The geographical entities have different names in different countries, based on terminology and local language. In the United Kingdom, the geographical entities are selected from about three thousand postal districts. In the United States, geographical entities are selected from approximately forty-two thousand zip codes. Furthermore, when such entities are selected, they are represented in the system 101 using a unique identification code, so that districts in countries that reuse the same naming or numbering can be uniquely identified.

The list of geographical entities is defined in accordance with areas selected for an advertising campaign. For example, an advertising campaign for a chain of grocery stores is directed at entities containing or near one or more of the grocery stores.

At step 203 the list of geographical entities 204 is supplied to the holdout manager 107. The holdout manager 107 processes the list of entities 204 along with audience movement signals 110, census data 111 and geographical data 112 to catagorize the supplied entities into four groups which are received at step 205. The groups 206 include Group A 207, Group B 208, Group C 209 and Group D 210. Group A 207 is a holdout group which defines geographical entities where audience behaviour is measured, but to which advertising content is not served. Group B 208 is a preferred group which contains geographical entities to which advertising content is served and resulting audience behaviour will be measured. Group C 209 contains geographical entities to which advertising content is served but in which audience behaviour is not measured. Group D 210 is a buffer group containing geographical entities to which advertising is not served and in which audience behaviour will not be measured.

At step 211 the groups 206 are transmitted to the real-time bidding system 106. At step 212 audience behaviour signals 109 are accumulated for places in group A 207 and group B 208 while the advertising campaign is run. This accumulation of statistics takes places over hours, days and weeks. During this time, other advertising campaigns may be configured and run simultaneously, and this is omitted from FIG. 2 for the sake of clarity.

At step 213 the accumulated audience behaviour data for the campaign is supplied to the uplift measurement server 108. At step 214 audience uplift data is received from the uplift measurement server 108. The received uplift data may be viewed on the configuring terminal 104 to determine the effectiveness of an advertising campaign. At step 215, campaign parameters are refined in response to the uplift data received at step 214, and steps 202 to 215 continue repeating with further refinements and improvements in the efficiency with which advertising content is served to an Internet-connected audience. It will be appreciated that uplift measurement is facilitated by the preferential transmission of advertising content signals to a preferred group 208 of potentially millions of devices 114 to 117 and excluding sending the same advertising content signals to one or more other groups. This establishes an optimal audience device configuration for subsequent measurement of audience uplift.

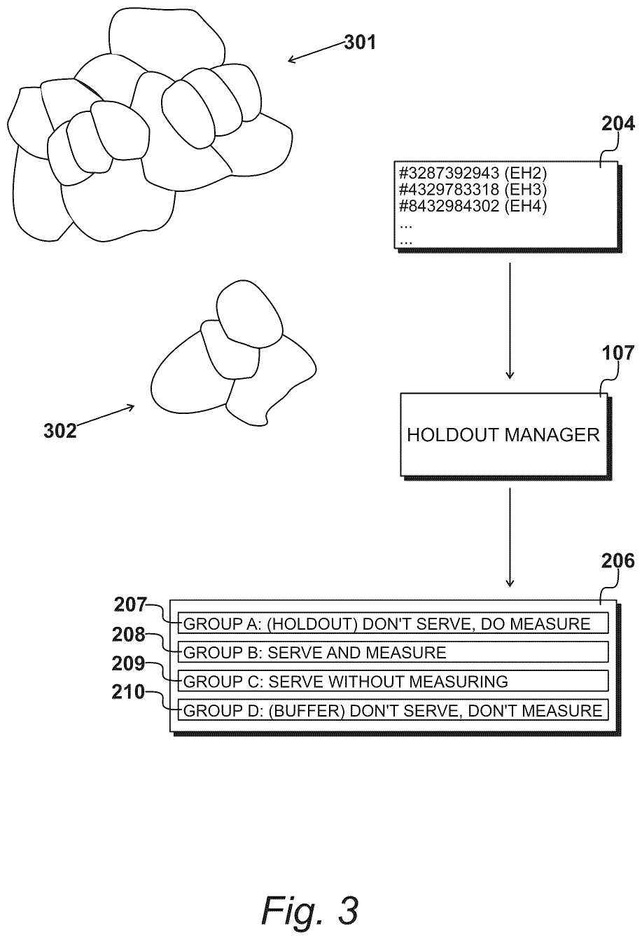

### FIG. 3

The effect of steps 202, 203 and 205 shown in FIG. 2 is illustrated in FIG. 3. Postal districts in multiple cities 301 and 302 are defined as geographical entities in the list 204 supplied to the holdout manager 107. The holdout manager 107 provides an output in the form of groups 206 that define which geographical entities in cities 301 and 302 should be served advertisements and where audience behaviour measurements should be made when the advertising campaign is running.

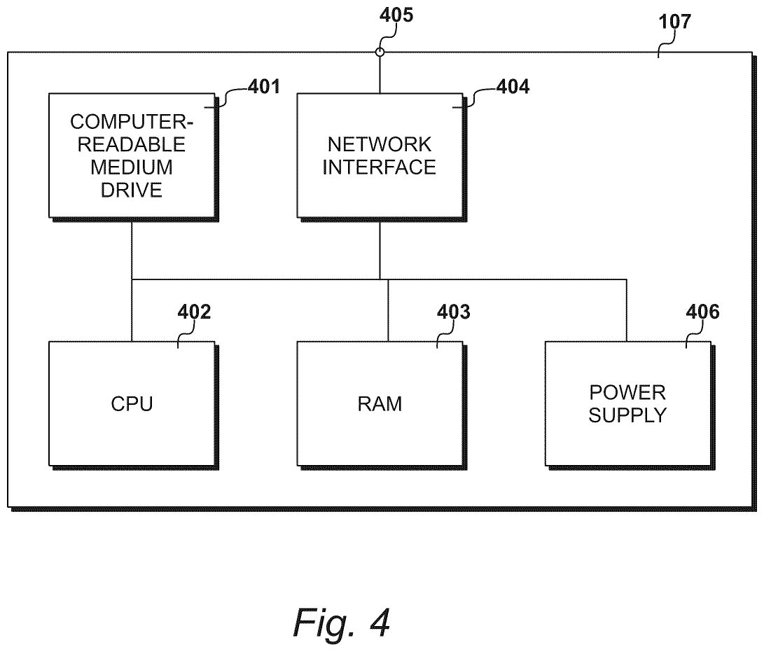

### FIG. 4

Hardware components of the holdout manager 107 shown in FIG. 1 are detailed in FIG. 4. The holdout manager hardware 107 is a computer system located in a server farm along with other system components 105 to 108. Each of these components may be virtualised, in such a way as to make most efficient use of available hardware. Each component 105 to 107 may use a fraction of a physical server. Conversely, each component 105 to 108 may use or migrate to multiple physical servers. Such details are omitted for the sake of clarity, and the holdout manager 107 is described with reference to the hardware shown in FIG. 4, which facilitates the required functionality.

Hardware components of the holdout manager 107 include a non-volatile computer-readable medium drive 401 that stores instructions and data for a central processing unit (CPU) 402. The drive 401 is a Solid-State Drive (SSD) that includes one terabyte of high-speed FLASH memory. Sixteen megabytes of random-access memory (RAM) 403 provide high speed instruction and data storage for the CPU 402 when it is executing instructions. A network interface 404 provides access to the Internet 102 via a local area network connection 405. A power supply 406 provides power to the components 401 to 404 of the holdout manager 107.

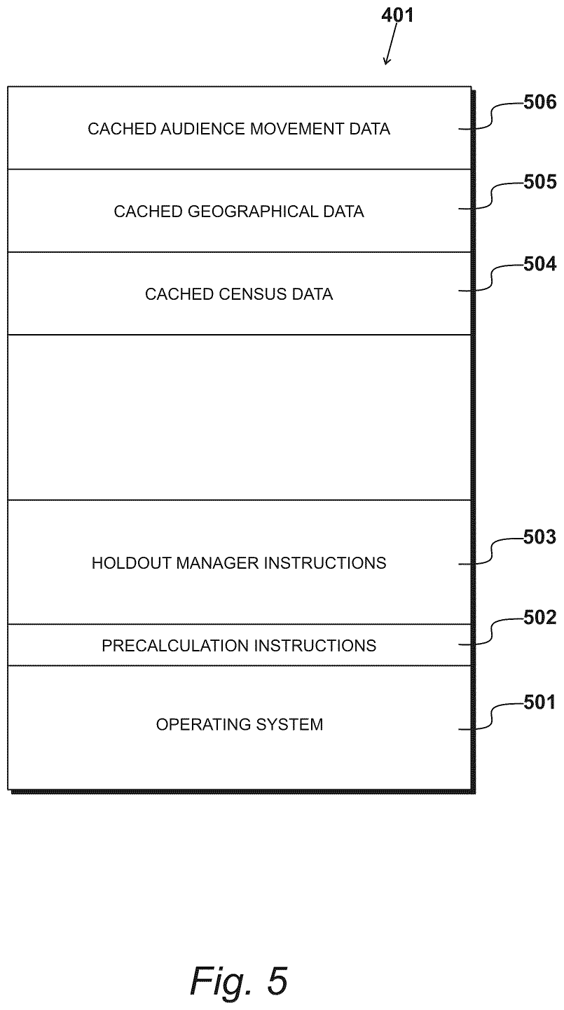

### FIG. 5

Contents of the drive 401 shown in FIG. 4 are detailed in FIG. 5. An operating system 501 provides hardware abstraction and task switching instructions for applications running on the holdout manager 107. Pre-calculation instructions 502 are executed by the CPU 402 to periodically update audience movement signals 110 and occasionally update geographical data 112. Holdout manager instructions 503 instruct the CPU 402 to process the list of geographical entities 204 and to produce data representing groups of entities 206 for an advertising campaign, including the holdout group 207 and a preferred group 208.

Contents of the drive 401 further include cached census data 504 which is data copied locally from census data 111 shown in FIG. 1. Cached geographical data 505 includes data copied locally from geographical data 112 shown in FIG. 1. Cached audience movement data 506 includes signals copied locally from audience movement signals 110 shown in FIG. 1.

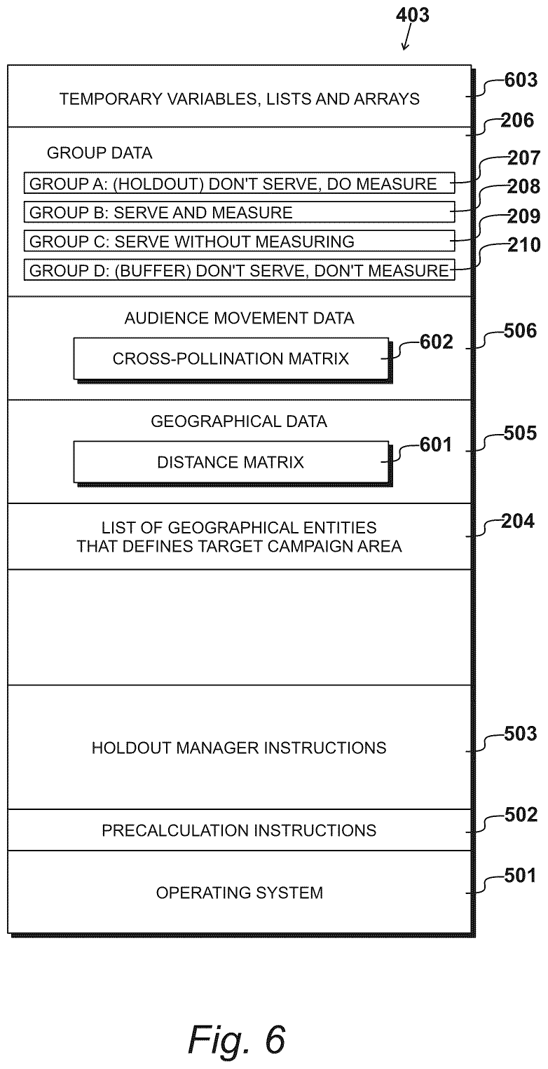

### FIG. 6

Contents of RAM 403 shown in FIG. 4 are detailed in FIG. 6. The operating system instruction 501 shown in FIG. 5 are copied to RAM 403 during their execution by the CPU 402. Pre-calculation instructions 502 and holdout manager instructions 503 are similarly copied into RAM 403 for execution by the CPU 402.

Cached geographical data 505 is also copied to RAM 403, and a subset of geographical data 505 is instantiated as a distance matrix 601 computed for geographical entities 204 in the target campaign area. Cached audience movement data 506 is copied into RAM 403, and a subset of audience movement data 506 is instantiated as a cross-pollination matrix 602 for geographical entities 204 in the target campaign area. The cross-pollination matrix 602 therefore includes and represents at least some of the audience movement signals 110.

Group data 206 is produced as a result of executing the holdout manager instructions 503 on the CPU 402, during which temporary variables, lists and arrays 603 are stored and accessed in RAM 403.

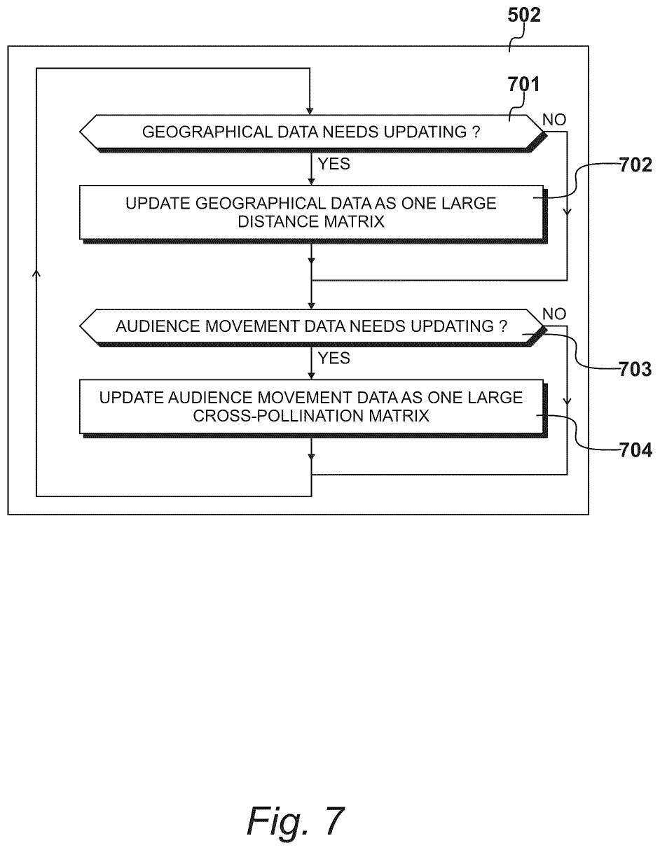

### FIG. 7

Steps performed by the pre-calculation instructions 502 shown in FIG. 6 are detailed in FIG. 7. At step 701 a question is asked as to whether the geographical data 112 needs updating. Geographical data 112 includes the distances between all unique pairings of geographical entities in a country or region. Given thousands of such pairings in a country, the computation is extremely intensive. Fortunately, the geographical data, once computed, rarely changes, and does so only when boundaries change, or an entity is added or removed. A further reason for updating geographical data 112 is a change in distance metric used to measure distances between geographic entities. If the geographical data does need updating, this is performed at step 702. At step 702, all necessary updates are made, so that the geographical data 112 is up to date.

Calculations performed at step 702 include applying a distance metric to permutations of entity pairs and storing the result in a very large matrix. Such calculations are preferably performed by distributing parallel calculations of the matrix to multiple servers in a server farm, using big data methods for parallelizing such calculations efficiently, as will be familiar to those skilled in the art.

At step 703, a question is asked as to whether audience movement signals 110 need updating with newly received audience movement signals. Audience movement can be seasonal in nature, and requires updates on a monthly or more frequent basis. If an update is required, this is performed at step 704.

For any given pair of geographical entities, X and Y, audience movement data may be obtained by counting how many devices, such as mobile phones 114 and 115, appear in both X and Y over a given time period. Thus, audience movement signals 110 are accumulated over a period of time, and combined to provide a count. An optimal time period is one week. In an embodiment, a time period of one day is used. Given thousands of such devices, counted using anonymous identification methods, it is possible to obtain a statistical measure of cross-pollination between X and Y. In the case that all devices seen in X are also seen in Y during the same week, the cross-pollination between X and Y is given the maximum value of one. If no devices from X are seen in Y during one week, the cross-pollination value is zero.

As with geographical data 112, updating audience movement signals 110 requires a lot of computation, due to there being millions of entity pairs. For this reason, big data methods are used, and the calculation is distributed across multiple servers when necessary.

Steps 701 to 704 are performed by the holdout manager as a background operation, and only use up computing resources when they are occasionally necessary.

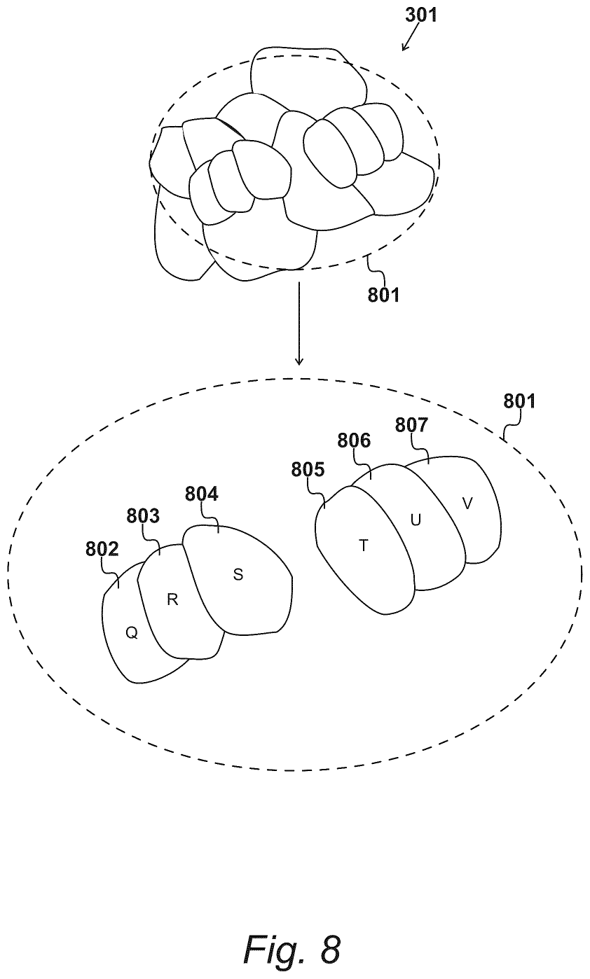

### FIG. 8

Geographical entities in the city 301 shown in FIG. 3 are detailed in FIG. 8. A region 801 includes selected postal districts Q 802, R 803, S 804, T 805, U 806 and V 807 that correspond to geographical entities used in the following examples of the processing steps performed by the holdout manager 107. It will be understood that, in practice, many hundreds or thousands of such geographical entities will be processed. A subset 802 to 807 is chosen for the sake of clarity.

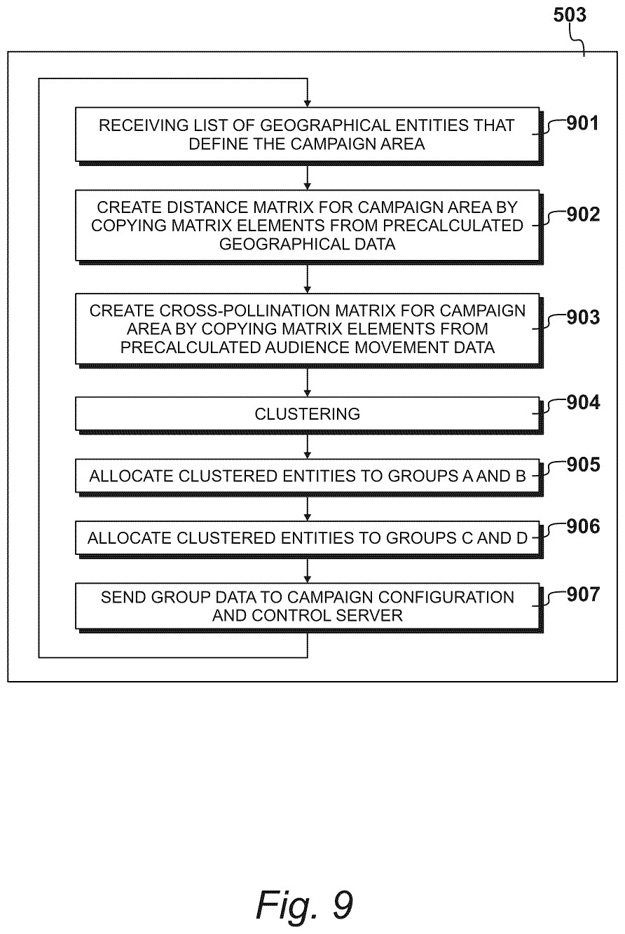

### FIG. 9

The steps performed by the holdout manager instructions 503 shown in FIG. 6 are detailed in FIG. 9. At step 901, the list of geographical entities 204 is received from the campaign configuration and control server 105. At step 902 a distance matrix is created for the campaign area, by copying matrix elements from the precalculated geographical data 112. At step 903 a cross-pollination matrix is created for the campaign area, by copying matrix elements from the audience movement signals 110.

Clustering is performed at step 904, in which geographical entities are allocated to clusters. At step 905, clustered entities are allocated to Group A 207 and Group B 208. At step 906, remaining clustered entities are allocated to Group C 209 and Group D 210. At step 907 data representing the groups 207, 208, 209 and 210 is sent to the campaign configuration and control server 105. Step 907 determines that advertising content will be served only to geographical entities in groups B 208 and C 209, and that audience behaviour will be measured only in geographical entities in groups A 207 and B 208.

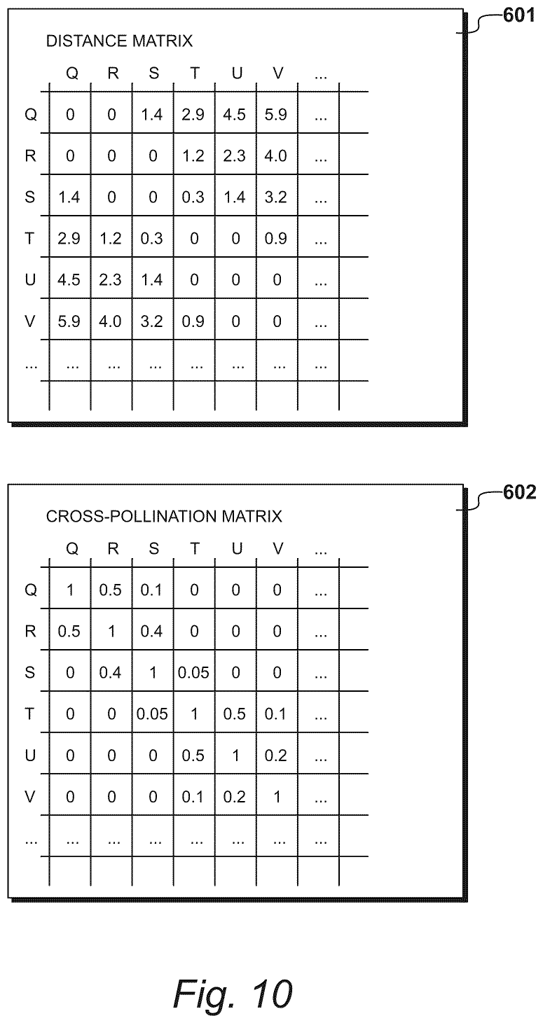

### FIG. 10

The result of performing steps 902 and 903 shown in FIG. 9 is illustrated in FIG. 10. The distance matrix 601 includes rows and columns for each of geographical entities Q, R, S, T, U and V 802 to 807. Neighbouring entities, such as Q and R, have a distance of zero, due to the fact that the distance metric applied in step 702 considers bordering entities to have no distance between them. Pairs, such as Q 802 and S 804 that do not share any border, have non-zero distance values. Distances are in kilometers. The distance matrix 601 is symmetric, so in practice only half of it needs to be stored in physical RAM 403. In practice, the distance matrix 601 for an advertising campaign may have hundreds or thousands of such rows and columns.

The cross-pollination matrix 602 is also symmetric. Full cross-pollination is seen only in the redundant case of an entity with itself. Practical cross-pollination values are usually much smaller, and for distant entities, may be zero or have statistically negligible values. The cross-pollination matrix 602 has the same size as the distance matrix 601.

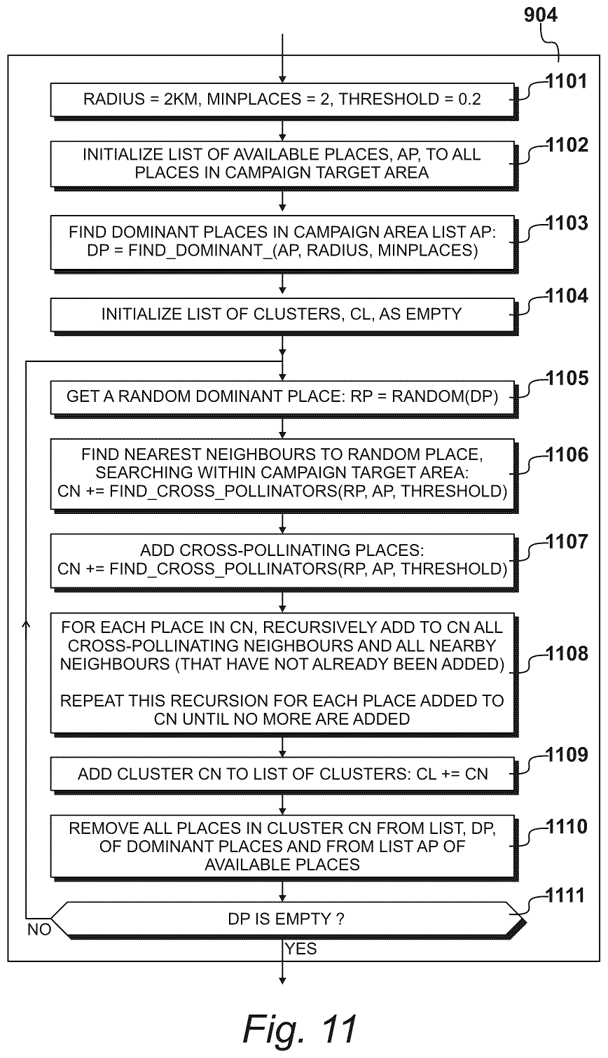

### FIG. 11

A goal when designing an advertising campaign is to set aside a portion of an audience which do not see the advertisements, so that A/B testing can be performed, resulting in the measurement of audience uplift due to the advertising campaign. Optimal design for such testing is complicated by the enormous number of permutations of comparable places in any significant geographical area. This is further complicated by audience movement between locations.

To solve these issues, the holdout manager 107 first performs clustering 904 prior to allocating geographical entities from the clusters to groups 206 at steps 905 and 906.

The clustering step 904 shown in FIG. 9 is detailed in FIG. 11. At step 1101 three constants are defined that affect subsequent operations. For the purposes of a brief and convenient description, geographical entities, such as postal districts 802 to 807, will be referred to as places. The terms geographical entity and place are interchangeable in the description that follows. At step 1102 a list of available places, AP, is initialized with all places in the campaign target area 301, 302.

At step 1103 dominant places are identified and stored as a list, DP. A dominant place is one that has two or more places nearby that are within a radius of two kilometers, in accordance with constants defined at step 1101. At step 1104 a list of clusters, CL, is initialized as empty.

At step 1105 a dominant place, RP, is randomly chosen from the list of dominant places, DP. At step 1106 its nearest neighbours are identified as a list, CN. Nearest neighbours are considered those within a radius of two kilometers of RP. At step 1107 cross-pollinating places are added to CN. Cross-pollinating places are those whose cross-pollination with RP exceeds a threshold of one fifth, in accordance with the constant defined at step 1101. This cross-pollination value is obtained from the cross-pollination matrix 602 detailed in FIG. 10.

At step 1108 a recursion is performed that effectively repeats steps 1106 and 1107 considering each place in the list CN as if it were RP. It will be appreciated that this recursion increases the size of the list CN until it naturally stabilises with some number of places, dependent upon the constants defined in step 1101. Cluster CN is then added to the list of clusters CL at step 1109. At step 1110 all places in cluster CN are removed from the list of dominant places, DP, and from the list of available places, AP.

At step 1111 a question is asked as to whether the list of dominant places is now empty. If not, steps 1105 to 1111 are repeated. Otherwise, clustering is complete, and the result is the list of clusters, CL. Each cluster contains one or more places. Contents of AP, DP, CL and CN are all stored as part of temporary memory 603 shown in FIG. 6.

The clustering performed by the steps of FIG. 11 considers places to be close to each other when they have significant cross-pollination, even though they may be a considerable distance apart. For example, two cities 301 and 302 may be geographically distant, but some cross-pollination may occur between some of their districts as a result of people commuting to and from work.

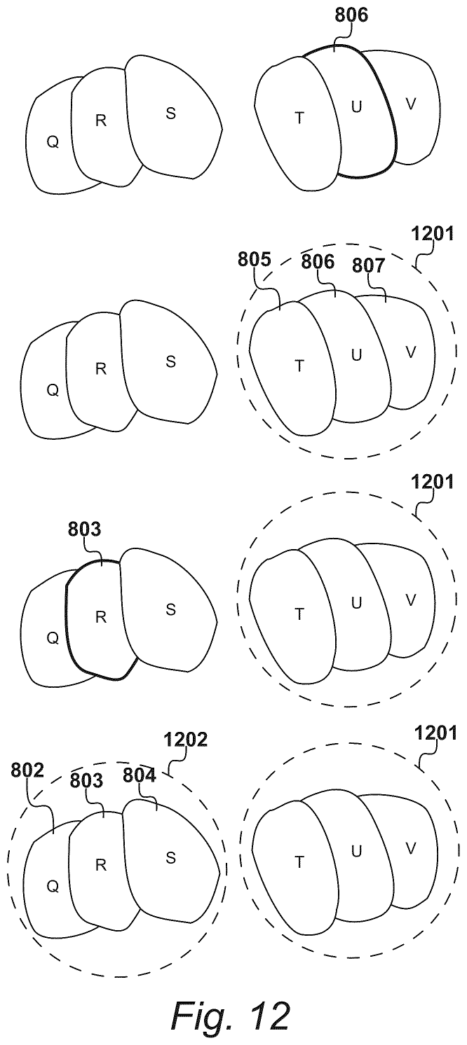

### FIG. 12

The clustering performed by the steps of FIG. 11 is illustrated in FIG. 12 using a minimal example of six postal districts Q, R, S, T, U and V, 802 to 807 considered in isolation from surrounding districts. District U 806 is randomly selected as a dominant district at step 1105. Steps 1106, 1107 and 1108 result in districts T 805 and V 807 being added to form a first cluster 1201. On a subsequent iteration of the clustering steps, district R 803 is randomly selected as a dominant district at step 1105. Districts Q 802 and S 804 are then added to form a second cluster 1202.

In practice, many tens, hundreds or thousands of such geographical entities are clustered, with each cluster's size being constrained by the constants defined at step 1101 in FIG. 11. Constants may be adjusted by country, region and season, in order to optimally provide clusters of the most suitable size.

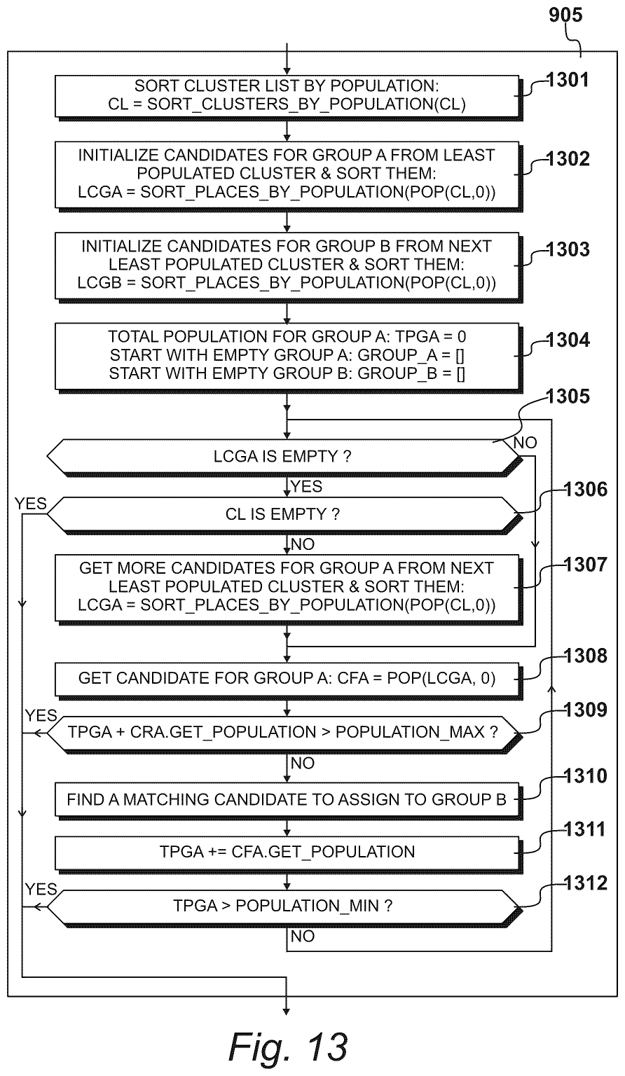

### FIG. 13

The step 905 of allocating entities to groups A and B shown in FIG. 9 is detailed in FIG. 13. It is desired to have a portion of the advertising campaign area allocated to Group A 207. Typically Group A 207 will represent ten percent of the population in the target campaign area. The steps of FIG. 13 are constrained by two parameters: POPULATION_MIN and POPULATION_MAX. These are set to slightly less and slightly more than ten percent of the campaign area population.

At step 1301 the cluster list, CL, is sorted in ascending order by population so that the cluster with the smallest population is first in the list. At step 1302 candidates for Group A are removed from the first cluster in CL, which is the cluster having the smallest population, and placed in a list LCGA. These candidates are themselves sorted in ascending order by population, so the least populous is first in LCGA. At step 1303 candidates for Group B are removed from the new first cluster in CL, which is the cluster having the second smallest population, and placed in a list LCGB. These candidates for Group B are also sorted in ascending order by population, so the least populous is first in list LCGB.

The reason for sorting in ascending order of population is to maximise granularity of population increments when aiming to satisfy the goal of having Group A's population between POPULATION_MIN and POPULATION_MAX.

At step 1304 the total population for Group A, TPGA, is set to zero, and Group A and Group B are initialized as empty.

At step 1305 a question is asked as to whether LCGA is empty. On the first iteration, this will be false. However, if it is empty, and at step 1306 the cluster list, CL, is also empty, this represents the end condition for allocating entities to groups A and B. If CL isn't empty, but LCGA is empty, at step 1307 more candidates for Group A are added to LCGA by repeating what was done earlier at step 1302. If LCGA did not require refilling, control is directed from step 1305 to step 1308.

At step 1308 a candidate place for Group A is removed from LCGA, from the top of the list, retrieving the least populous available, and assigning it to CFA. At step 1309, if the combination of the population of CFA with TPGA is greater than POPULATION_MAX, this represents the end condition for allocating entities to groups A and B.

Otherwise, at step 1311, a search is performed to find a matching candidate entity to CFA that will be allocated to Group B 208. Step 1310 will be detailed below. At step 1311 CFA's population is added to TPGA. At step 1312, if TPGA is now above POPULATION_MIN, this represents the end condition for allocating entities to groups A and B. Alternatively, control is directed back to step 1305 and steps 1305 to 1312 are repeated until the population represented by Group A meets the criteria specified by POPULATION_MIN and POPULATION_MAX, thereby ensuring that Group A represents approximately ten percent of the population of the campaign target area.

It will be appreciated that the population allocated to preferred Group B does not need to be so constrained, because Group B will be served advertisements, so there is no cost associated with assigning potential audience members to Group B.

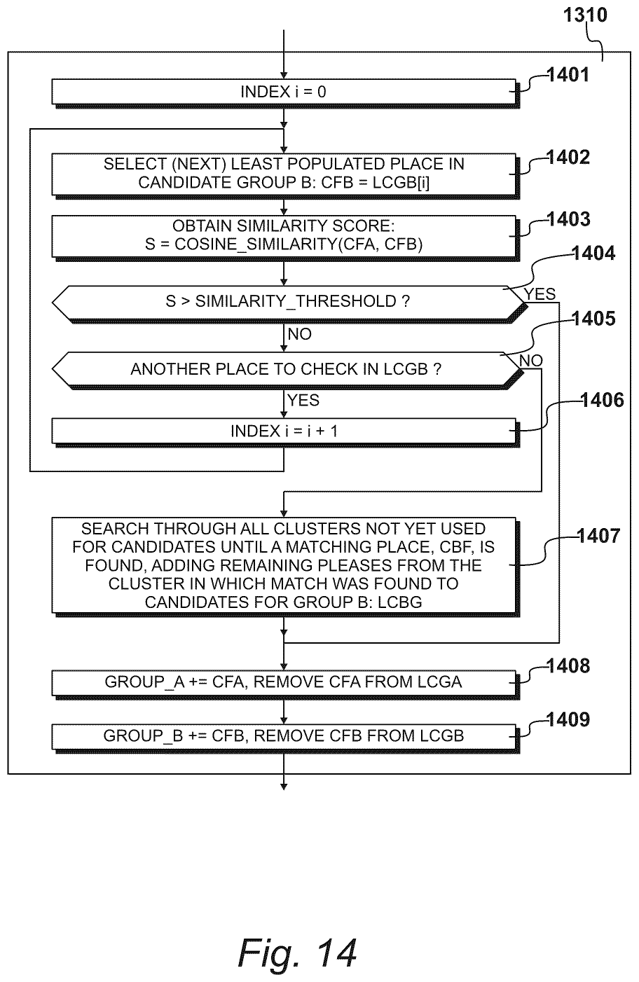

### FIG. 14

The step 1310 of finding a matching candidate to assign to Group B, shown in FIG. 13, is detailed in FIG. 14. At step 1401 an index, i, is set to zero. At step 1402 the next least populous place in LCGB is copied into a candidate for Group B, CFB. At step 1403 the similarity between CFA and CFB is obtained using a cosine similarity function. Similarity is based upon factors in census data 111, cached at 504, that define average household income, house ownership, number of cars per household, and so on, for a geographical entity. The similarity score, S, takes a value between minus one and one. If the similarity score is greater than a threshold value of 0.9, CFA and CFB are considered to be well-matched. If not, at step 1405 LCGB is checked to see if it contains other candidates for Group B. If there are more candidates, the index, I, is incremented at step 1406 and steps 1402 to 1406 are repeated until either a match is found, or until there are no more candidates in LCGB.

If the contents of LCGB are exhausted before a match for CFA is found, control is directed from step 1405 to step 1407. At step 1407 a search is made through all unused clusters until a matching place is found. In practice, this is nearly always successful. Other places in the same cluster in which the match is found are added to the candidates for Group B, LCGB. The effect of this is to refill LCGB and enable steps 1305 to 1312 of FIG. 13 to continue iterating.

Once a match has been found, either at step 1404 or as a result of step 1407, at step 1408 CFA is added to Group A 207 and removed from LCGA. Then, at step 1409, CFB is added to Group B 208 and removed from LCGB. The effect of this is to build up Group A to be similar to Group B, such that behaviours of an audience in Group A can be expected to be very similar to behaviours of an audience in Group B. By withholding advertising content from Group A, the effectiveness of an advertising campaign can then be measured. By clustering 904 and then allocating 905, permutations are reduced so that a computer system such as the one shown in FIG. 4 can be used to perform allocation.

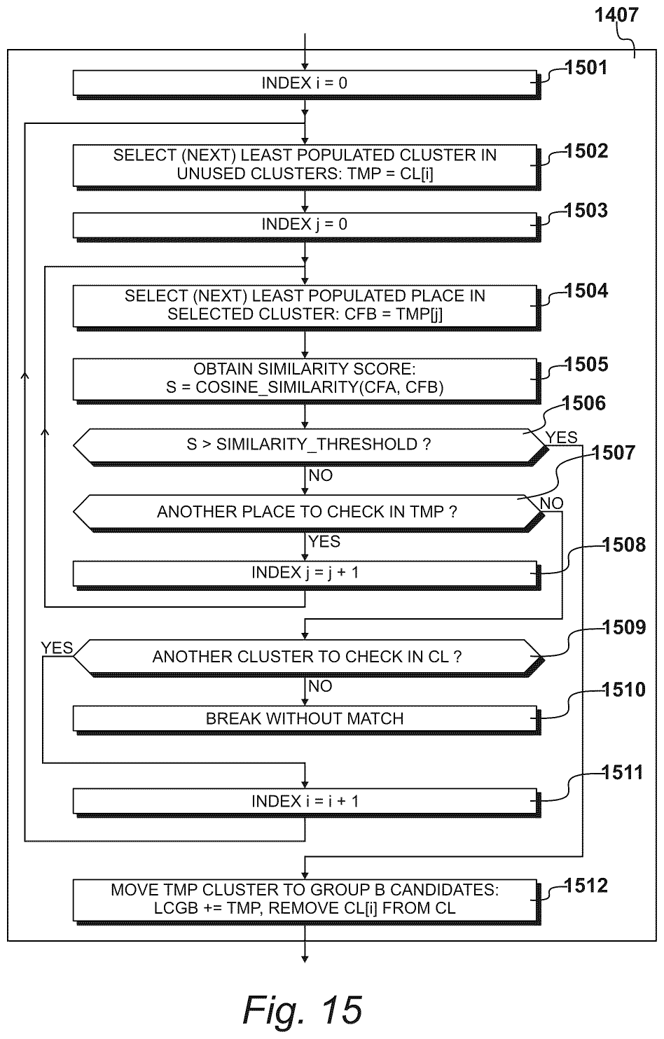

### FIG. 15

The step 1407 of searching in unallocated clusters for a match, shown in FIG. 14, is detailed in FIG. 15. At step 1501 an index, i, is set to zero. At step 1502 the next least populated cluster in CL is selected and identified as TMP. At step 1503 a second index, j, is set to zero. At step 1504 the next least populated place in TMP is selected as CFB. At step 1505 the cosine similarity between CFA and CFB is obtained. If the similarity score obtained at step 1505 is greater than a threshold of 0.9, CFA and CFB are considered matched. Alternatively, if TMP is not empty at step 1507, at step 1508 index j is incremented and steps 1504 onwards are repeated.

If TMP becomes empty before a matching place is found, control is directed to step 1509 where a check is made that there is another cluster to check in CL. In practice this is nearly always the case. However, in exceptional circumstances a match cannot be found and other steps must be taken, such as changing the similarity threshold. Usually, additional clusters will be available, and index i is incremented at step 1511 before steps 1502 onwards are repeated. Eventually a match between CFA and CFB is found. At step 1512 the contents of TMP are moved to LCGB and the cluster represented by TMP is removed from CL.

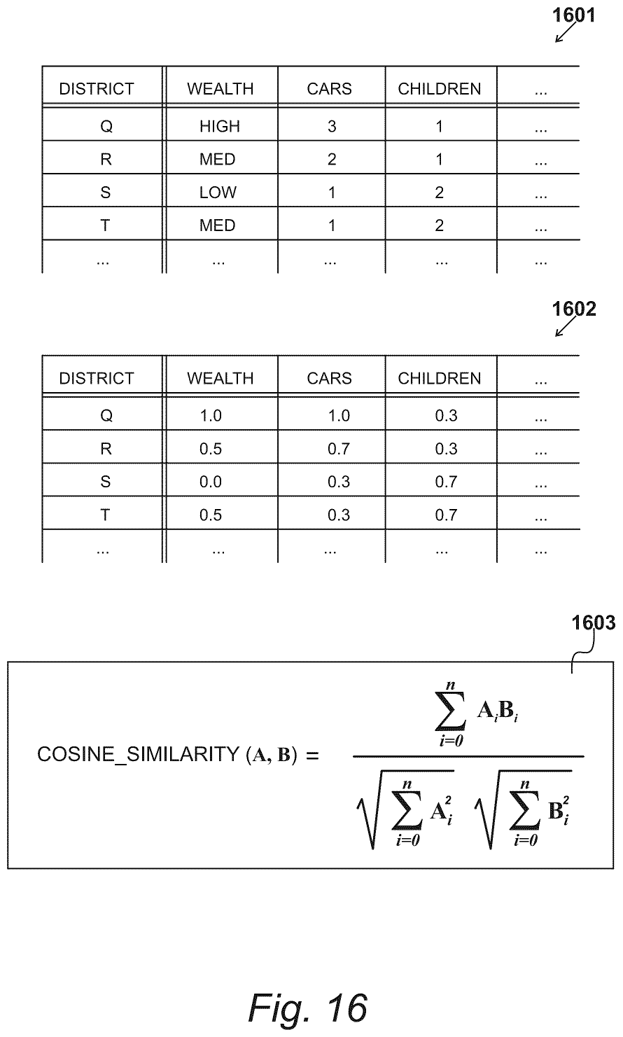

### FIG. 16

Implementation of the steps 1403 and 1505 of obtaining the cosine similarity of two districts shown in FIG. 14 and FIG. 15 is detailed in FIG. 16 using an example. On average, households in district Q 802 have high wealth, three cars and one child. This information is available from census data 111. Households in district R 803 have different characteristics. Table 1601 shows these characteristics as integer values, although in practice these will usually be fractional. Table 1602 provides the same information, but the values have been normalized to fit in a range of zero to one. This is so that the contributions to the calculated cosine similarity will be equally weighted. For example, wealth, cars and children will contribute equally to the resulting correlation between pairs of districts.

A method of calculation of cosine similarity is shown at 1603, in which the normalized characteristics for each of two districts is considered as a vector. The resulting similarity score has a range from minus one to one. The calculation 1603 may also be considered as measuring a correlation between entity characteristics.

In an embodiment, similarity scores for all places within a country or geographical region are precalculated at the same time as audience movement data and geographical data. Elements from the precalculated similarity scores are then copied locally into a similarity matrix similar in structure to those shown in FIG. 10 and stored in RAM 403. The similarity score for a pair of geographical entities is obtained by looking-up a precalculated value. In other embodiments, the similarity score is obtained by performing the calculation 1603 whenever entities are compared.

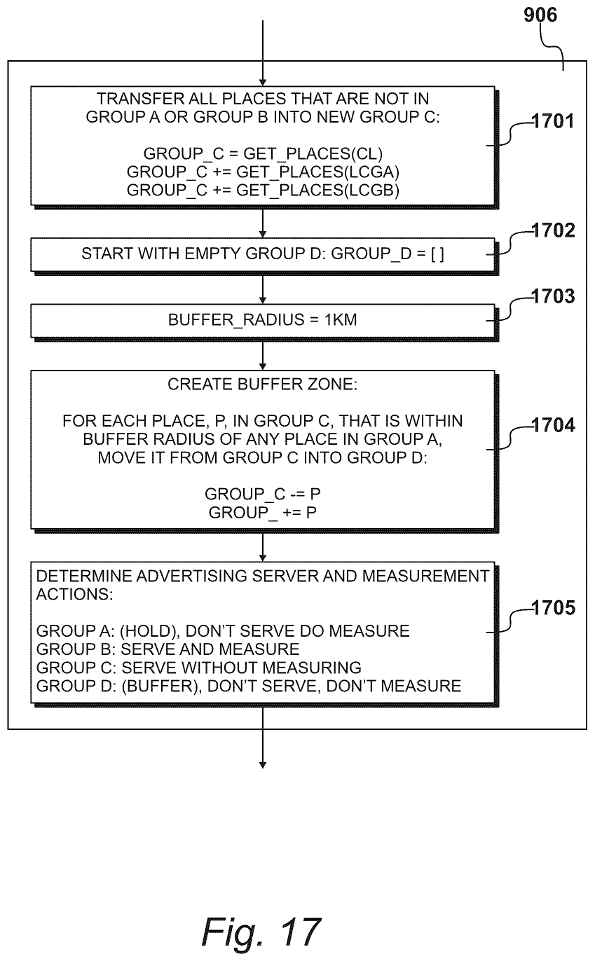

### FIG. 17

The step 906 of allocating clustered entities to groups C and D, shown in FIG. 9, is detailed in FIG. 17. At step 1701 all places that were not allocated into Group A or Group B are put into new Group C 209. At step 1702 an empty Group D 210 is initialized. At step 1703 a buffer radius is defined as one kilometer. This value may be set differently, typically in a range from one hundred meters to one kilometer., depending on region.

At step 1704 a buffer zone is created. For each entity in Group C 209 that is within the buffer radius defined at step 1703, the entity is moved from Group C 209 into Group D 210. Group D then provides a buffer zone around the holdout group, Group A, so that audience movement between Group A and neighbouring geographical entities does not reduce the accuracy of uplift measurements made by comparing subsequent audience behaviours in groups A and B. Group D 210 is considered to be a buffer group.

At step 1705 advertising server and audience measurement actions are determined in accordance with reference to Group A 207, Group B 208, Group C 209 and Group D 210.

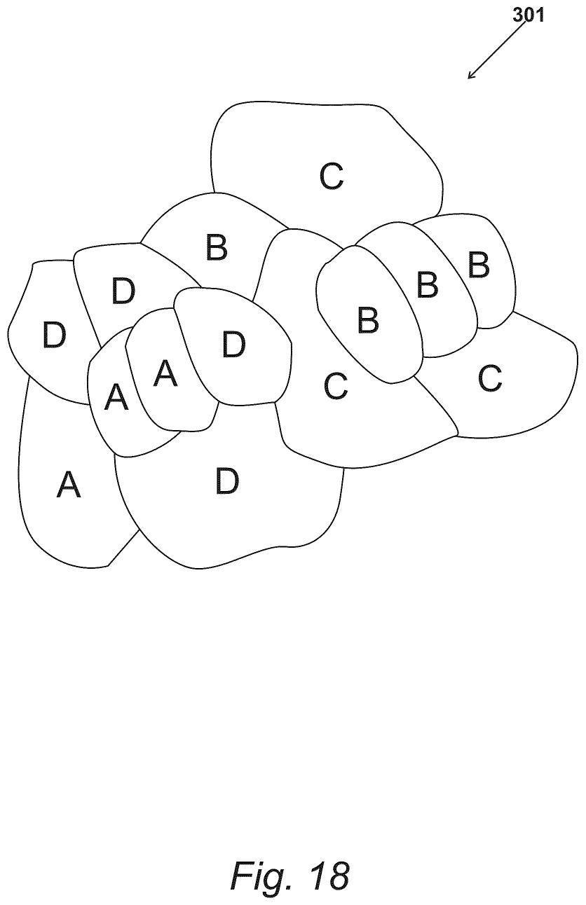

### FIG. 18

The result of creating a buffer zone in accordance with the step 1704 shown in FIG. 17 is illustrated in FIG. 18. Districts allocated to Group A 207 are separated from districts allocated to Group C 209 by districts allocated to Group D 210.

Allocation to all four groups 206 determines where advertising content will be served and where resulting audience behaviour will be measured. Clustering 904 makes group allocation 905 and 906 computationally tractable even for campaigns that have a target area containing thousands of postal districts. Clustering is performed in response to geographical data 112, 601 by processing the geographical data 112, 601 with audience movement signals 109, 602 to define a plurality of entity clusters 1201, 1202.

Audience similarity for selected pluralities of geographical entities is quantified by obtaining 1403 the cosine similarity between entities in different clusters 1201, 1202. Similar entities are allocated 1408 to a holdout group 207 and allocated 1409 to a served group 208 in response 1404, 1506 to their similarity score.

As a result, it is possible to determine 907 where advertising content will be served and where audience behaviours will be measured, in such a way as to ensure that audience uplift can be accurately calculated while respecting audience privacy.

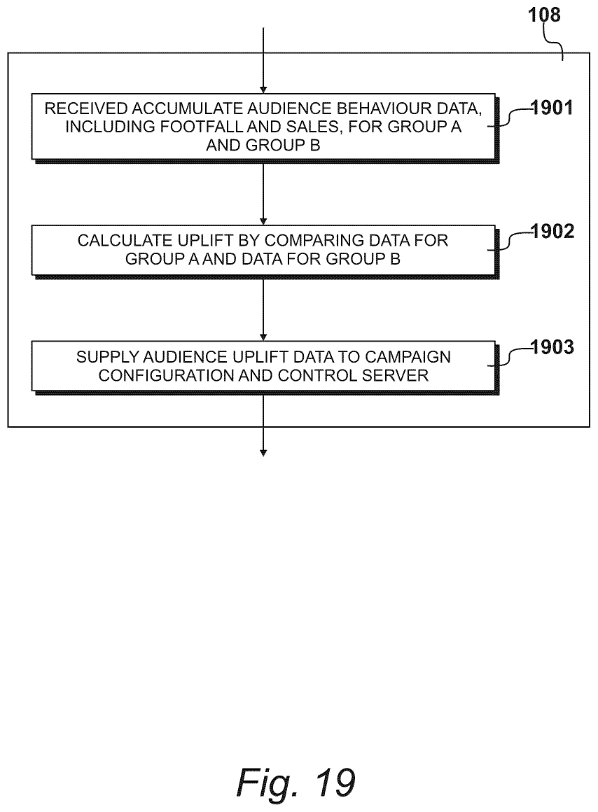

### FIG. 19

After an advertising campaign has been run for some time, such as a week or a month, statistically significant observations can be made in order to determine audience uplift resulting from the campaign. Steps performed by the audience uplift server 108 shown in FIG. 1 are summarized in FIG. 19.

At step 1901 accumulated audience behaviour data is received from audience behaviour signal storage 109, including footfall and product sales for districts allocated to Group A 207 and Group B 208. Footfall data is a simple count of devices in or near a store location where advertised products are available, such as a grocery store chain. Sales data includes sales of the product or products advertised in the campaign.

At step 1902 uplift is calculated by comparing this audience behaviour data for Group A 207, which is the holdout group to which advertising content is not served, and audience behaviour data for Group B 208, to which advertising content is served.

At step 1903 audience uplift data is supplied to the campaign configuration and control server 105, thereby making it available to an operator of the configuration terminal 104.

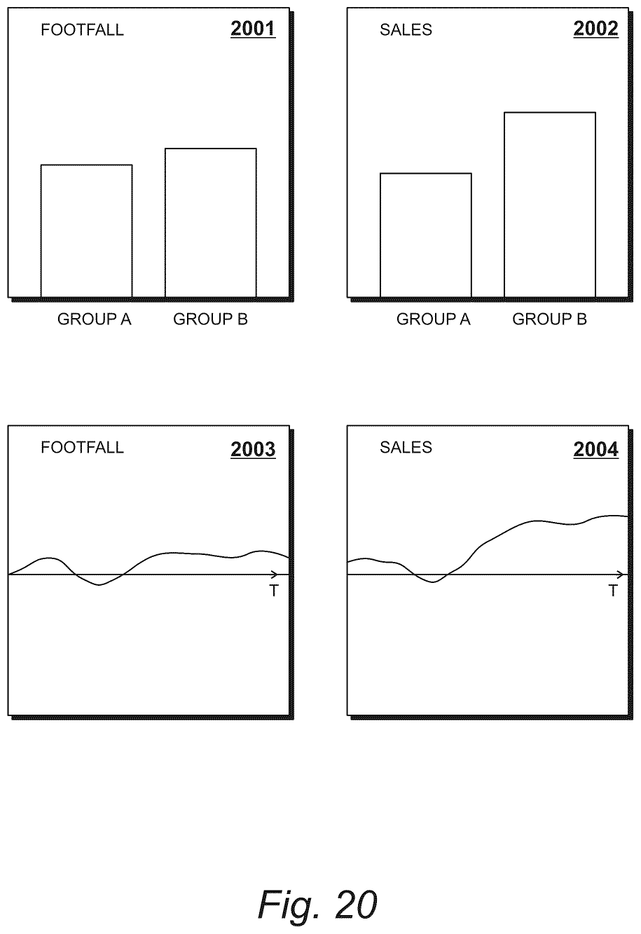

### FIG. 20

The uplift measurements produced by the steps shown in FIG. 19 are illustrated in FIG. 20. At 2001 footfall in the holdout group, Group A 207, to which advertising content was not served, is slightly lower than footfall in Group B over the same period. This shows that the advertising campaign has probably had some effect. At 2002 sales increase more markedly than footfall 2001 over the same interval.

At 2003, time series data for the difference in footfall between districts in Group A and districts in Group B shows a more detailed picture of the effect of the campaign over time. At 2004, time series data for sales shows a similar but stronger effect. The data shown in FIG. 20 may be displayed graphically on the configuring terminal 104 or stored for subsequent use.

The accuracy achieved by the uplift measurements illustrated in FIG. 20 is only possible by virtue of the preferential transmission 211 of advertising content signals to audience devices for audience members in the preferred group 208, thereby establishing an optimal audience device configuration for the subsequent measurement of audience uplift.

What we claim is:

1. A method performed by a processing system configured to receive audience movement signals responsive to audience movement between a plurality of geographical entities and to process the movement signals with audience area data representing the plurality of geographical entities; the method comprising the steps of:
clustering the entities by processing the audience movement signals with the audience area data to define a plurality of entity clusters;
quantifying audience similarity for selected pluralities of the geographical entities by obtaining similarity scores for entities in different entity clusters;
allocating similar entities to a holdout group and a preferred group in response to their quantified audience similarity; and
preferentially transmitting content signals to audience devices for audience members in the preferred group, thereby establishing an optimal audience device configuration for subsequent measurement of audience uplift.

2. The method of claim 1, further including the step of measuring audience uplift in response to signals for a resulting audience behavior in the preferred group and signals for a corresponding audience behavior in the holdout group.

3. The method of claim 2, further including the step of measuring the audience uplift by comparing the signals for a resulting audience behavior in the preferred group with the signals for a corresponding audience behavior in the holdout group.

4. The method of claim 1, wherein the step of allocating further includes the step of allocating a geographical entity to a buffer group that geographically separates a portion of the holdout group from the preferred group.

5. The method of claim 4, wherein the step of allocating further includes the step of allocating unallocated geographical entities to a group whose audience will be served the content and for which resulting audience behavior will not be measured.

6. The method of claim 1, wherein the step of clustering includes the step of defining the plurality of entity clusters in response to the geographical data in a distance matrix.

7. The method of claim 6, further including the step of pre-calculating elements of the distance matrix.

8. The method of claim 1, wherein the step of clustering includes the step of defining the plurality of entity clusters in response to the audience movement signals in a cross-pollination matrix.

9. The method of claim 8, further including the step of pre-calculating elements of the cross-pollination matrix.

10. The method of claim 1, wherein the step of quantifying audience similarity includes the step of obtaining the similarity scores by calculating a cosine similarity between normalized audience characteristics for respective entities.

11. Apparatus for serving content to audience devices on a network in response to audience movement signals responsive to audience movement between a plurality of geographical entities and to process the movement signals with audience area data representing the plurality of geographical entities; the apparatus comprising at least one processor configured to perform the steps of:
clustering the entities by processing the audience movement signals with the audience area data to define a plurality of entity clusters;
quantifying audience similarity for selected pluralities of the geographical entities by obtaining similarity scores for entities in different entity clusters;
allocating similar entities to a holdout group and a preferred group in response to their quantified audience similarity; and
preferentially transmitting content signals to audience devices for audience members in the preferred group, thereby establishing an optimal audience device configuration for subsequent measurement of audience uplift.

12. The apparatus of claim 11, wherein the at least one processor is further configured to measure audience uplift in response to signals for a resulting audience behavior in the preferred group and signals for a corresponding audience behavior in the holdout group.

13. The apparatus of claim 12, wherein the at least one processor is further configured to measure the audience uplift by comparing the signals for a resulting audience behavior in the preferred group with the signals for a corresponding audience behavior in the holdout group.

14. The apparatus of claim 11, wherein the at least one processor is further configured such that the step of allocating includes the step of allocating a geographical entity to a buffer group that geographically separates a portion of the holdout group from the preferred group.

15. The apparatus of claim 14, wherein the at least one processor is further configured such that the step of allocating includes the step of allocating unallocated geographical entities to a group whose audience will be served the content and for which resulting audience behavior will not be measured.

16. The apparatus of claim 11, wherein the at least one processor is further configured such that the step of clustering includes the step of defining the plurality of entity clusters in response to the geographical data in a distance matrix.

17. The apparatus of claim 16, wherein the at least one processor is configured to pre-calculate elements of the distance matrix.

18. The apparatus of claim 11, wherein the at least one processor is configured to define the plurality of entity clusters in response to the audience movement signals in a cross-pollination matrix.

19. The apparatus of claim 18, wherein the at least one processor is configured to pre-calculate elements of the cross-pollination matrix.

20. The apparatus of claim 11, wherein the at least one processor is configured such that the step of quantifying audience similarity includes the step of obtaining the similarity scores by calculating a cosine similarity between normalized audience characteristics for respective entities.

21. A non-volatile computer-readable medium having instructions stored upon it wherein said instructions configure a computer system for serving content to audience devices on a network in response to audience movement signals responsive to audience movement between a plurality of geographical entities and to process the movement signals with audience area data representing the plurality of geographical entities by performing steps of:
clustering the entities by processing the audience movement signals with the audience area data to define a plurality of entity clusters;
quantifying audience similarity for selected pluralities of the geographical entities by obtaining similarity scores for entities in different entity clusters;
allocating similar entities to a holdout group and a preferred group in response to their quantified audience similarity; and
determining to transmit content signals to audience devices for audience members in the preferred group, thereby establishing an optimal audience device configuration for subsequent measurement of audience uplift.

22. The computer-readable medium of claim 21, further including instructions to measure audience uplift in response to signals for a resulting audience behavior in the preferred group and signals for a corresponding audience behavior in the holdout group.

23. The computer-readable medium of claim 21, further including instructions for allocating a geographical entity to a buffer group that geographically separates a portion of the holdout group from the preferred group.

24. The computer-readable medium of claim 21, further including instructions such that the step of clustering includes the step of defining the plurality of entity clusters in response to the geographical data in a distance matrix.

25. The computer-readable medium of claim 21, further including instructions to define the plurality of entity clusters in response to the audience movement signals in a cross-pollination matrix.
